(19) United States
(12) Patent Application Publication
(10) Pub. No.: US 2022/0391793 A1
(43) Pub. Date: Dec. 8, 2022

(54) CONTINUOUS RISK ASSESSMENT OF INDIVIDUAL ELEMENTS OF A SYSTEM

(71) Applicant: EQUIFAX INC., Atlanta, GA (US)

(72) Inventors: Thomas Alan LATIMER, Alpharetta, GA (US); Michael Shawn DOOLEY, Alpharetta, GA (US); Michael John REITH, Alpharetta, GA (US); Michael Dale MCBURNETT, Cumming, GA (US)

(21) Appl. No.: 17/341,012

(22) Filed: Jun. 7, 2021

(51) Int. Cl. G06Q 10/06; G06F 40/20; G06F 16/951

(52) U.S. Cl. CPC G06Q 10/0635; G06F 40/20; G06F 16/951

(57) ABSTRACT

Systems and methods for continuously assessing risks associated with individual elements or entities of a system are provided. A risk evaluation system receives a request for evaluating a risk associated with an entity providing a certain function or service and generates a risk profile for the entity based upon the function or service provided by the entity. In response to determining that a time for assessing the risk associated with the entity has arrived, the risk evaluation system generates attributes of the entity and a predicted risk associated with the entity by inputting the attributes of the entity into an explainable risk assessment machine-learning model. The risk evaluation system generates explanatory data associated with the entity and sends the explanatory data indicating the attributes of the entity causing the predicted risk to be higher than a threshold and a notification to another computing device for use to further evaluate the entity.

### TECHNICAL FIELD

This disclosure relates generally to reducing the risk associated with service-providing elements or entities of a system by continuously assessing the risks associated with these individual elements or entities.

### BACKGROUND

Assessing risks associated with individual elements or entities of a system helps to keep the risk of running the overall system low. For example, a large-scale computing system may include a large number of elements (e.g., hardware or software) configured for implementing different functionalities or services, such as elements configured for performing computing functionalities, elements for providing storage services, and elements for enabling network communication of the system with other systems. In another example, in an enterprise environment, various entities may be engaged to provide different services and assessing the risks associated with these entities help to identify and solve problems earlier.

However, existing systems either lack a mechanism for keeping track of the risks associated with these elements or entities or the tracking is performed manually, which is time-consuming and can only be performed occasionally. As a result, the high risk associated with the individual elements or entities are undetected or detected too late to be addressed which eventually leads to a system's failure in meeting requirements, such as service level agreement requirements or regulatory requirements.

### SUMMARY

Various aspects of the present disclosure involve continuously assessing the risks associated with individual service-providing elements or entities for a system. In one example, a risk evaluation system receives a request for evaluating a risk associated with an entity providing a function or service. The risk evaluation system generates a risk profile for the entity based, at least in part, upon the function or service provided by the entity. The risk profile includes a risk assessment level indicating at least a frequency for assessing the risk associated with the entity. In response to determining, based on the risk profile, that a time for assessing the risk associated with the entity has arrived, the risk evaluation system generates attributes of the entity based on updated information associated with the entity. The attributes of the entity include a relationship between the entity and a list of high-risk entities. The relationship is determined by obtaining the list of high-risk entities from an external data source and determining the relationship between the entity and the list of high-risk entities. The risk evaluation system generates, using an explainable risk assessment machine-learning model, a predicted risk associated with the entity by inputting the attributes of the entity to the explainable risk assessment machine-learning model. The risk evaluation system further generates, using the explainable risk assessment machine-learning model, explanatory data associated with the entity based on the predicted risk being higher than a threshold. The explanatory data indicates the attributes of the entity that cause the predicted risk to be higher than the threshold. The risk evaluation system sends the explanatory data and notification to another computing device for use in further evaluating the entity based on the explanatory data and modifying the entity.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The foregoing, together with other features and examples, will become more apparent upon referring to the following specification, claims, and accompanying drawings.

FIG. 1 is a block diagram depicting an example of a risk assessment system for continuously assessing risks associated with the individual service-providing elements or entities for a system, according to certain aspects of the present disclosure.

FIG. 2 is a flow chart illustrating an example of a process for continuously assessing risks associated with the individual service-providing elements or entities for a system, according to certain aspects of the present disclosure.

FIG. 3 is a diagram illustrating the various stages involved from the addition of the element or entity to the system to the removal of element or entity from the system, according to certain aspects of the present disclosure.

FIG. 4 is a diagram illustrating the risks associated with an element or an entity as determined and predicted over time, according to certain aspects of the present disclosure.

FIG. 5 is a block diagram depicting an example of a computing system suitable for implementing aspects of the techniques and technologies presented herein.

### DETAILED DESCRIPTION

Certain aspects and features of the present disclosure involve continuously assessing risks associated with individual service-providing elements or entities for a system. A risk assessment server, in response to receiving a request for evaluating risks associated with an element or entity configured for providing a certain function or service for a system, generates a risk profile for the element or entity. The risk profile includes a risk assessment level and is generated based on the function or service provided by the element or entity. The risk assessment server evaluates the risks of the element or entity as specified by the risk assessment level. Each risk assessment includes generating using, an explainable risk assessment machine-learning model, a predicted risk associated with the element or entity by inputting attributes of the element or entity to the explainable risk assessment machine-learning model. The risk assessment server further generates explanatory data associated with the predicted risk. The predicted risk and the explanatory data are sent to another computing device for use to further evaluate the element or entity according to the explanatory data.

For example, the risk assessment server can maintain a risk record repository configured for storing risk assessment records for elements or entities associated with the system. Each risk assessment record is generated in response to an element or an entity being added to the system. For instance, a risk assessment server receives a request for evaluating a risk associated with an element or an entity configured for providing a certain function or service to the system. In response to the request, the risk assessment server obtains the information associated with the element or entity. If the element is a hardware computer component (e.g., a processor or chip configured for performing computing functionalities, a storage device for providing storage services, and a network card for enabling network communication), the risk assessment server obtains information such as the model number of the element, the manufacturer of the element, the specifications of the element, and so on. If the element is a software component, the risk assessment server obtains information of the software module such as the version number of the software, the environment or platform that supports the execution of the software, the developer of the software, and so on. If the element or entity is a company or other service provider, the risk assessment server obtains the information of the entity such as the name and address of the entity.

Based on the obtained information of the element or entity, an initial risk evaluation can be performed. For instance, the risk assessment server or another computing device can execute a cybersecurity tool to evaluate a website associated with the element or entity (e.g., a website describing the element or entity, a website hosted by the entity) and to generate a cybersecurity report. The risk assessment server or another computing device may also obtain, for example from the Internet, other public information of the element or entity, such as the financial data or other data associated with the entity. Data that cannot be publicly obtained may also be obtained, for example, through user input.

The risk assessment server or another computing device can perform the initial risk evaluation based on the gathered information. If it is determined based on the initial risk evaluation that the element or entity can be included in the system, the risk assessment server creates a risk profile for the element or entity in the risk record repository. The risk profile comprises a risk assessment level indicating at least a frequency for assessing the risk associated with the element or entity. In one example, the risk assessment level is determined based on the function or service provided by the element or entity. If the element or entity is engaged to provide critical functions or services or involve confidential information of the system, the risk assessment level for the element or entity can be set to be high. As a result, the element or entity will be evaluated more frequently. For elements or entities providing less important functions or services, the risk assessment level for the element or entity can be set to be medium or low and risk assessment can be performed less frequently. The risk assessment server further evaluates the risks of the element or entity periodically and continuously according to the frequency.

In each evaluation, the risk assessment server generates attributes of the element or entity based on updated information associated with the element or entity. For example, the risk assessment server can obtain a list of high-risk entities from an external data source and determines a relationship between the element or entity and the list of high-risk entities. The determination can be made based on, for example, a keyword associated with the element or entity that is extracted using natural language processing from the information associated with the element or entity. The keyword can be the name of the hardware device, the name of the company manufacturing the device, a key person of the company or entity, and so on. The list of high-risk entities may be a list of recalled devices, a list of devices that are incompatible with the computing environment of the system, or a list of dangerous or unwelcoming individuals. The risk assessment server can be configured to generate other attributes based on other information related to the element or entity that are obtained or updated after the initial risk assessment.

The risk assessment server further inputs the attributes of the element or entity to the explainable risk assessment machine-learning model to generate a predicted risk associated with the element or entity. The predicted risk is compared with a threshold value of risk to determine if the element or entity has a high risk. If not, the risk assessment server records the data associated with the current assessment in the risk record repository and continues to monitor the risk of the element or entity according to the risk profile.

If the predicted risk is higher than the threshold, the risk assessment server further uses the explainable risk assessment machine-learning model to generate explanatory data identifying the attributes that cause the high risk. The risk assessment server sends a notification along with the predicted risk and the explanatory data to another computing device. The notification will cause a more detailed risk analysis of the element or entity, such as the analysis performed in the initial risk assessment. In some examples, the detailed risk analysis is performed for the attributes that cause the high risk as indicated in the explanatory data. Based on the further analysis, the element or entity may be modified to reduce the risk brought by the element or entity to the system. The modifications include, but are not limited to, removing the element or entity from the system, replacing the element or entity with another element or entity providing the same or similar function or service, or repairing, rectifying, or reforming the element or entity to reduce the risk.

In some examples, the risk assessment server further updates the risk profile of the element or entity based on the data obtained during the risk assessment and the predicted risk. For instance, if the service or function provided by the element or entity becomes less important as the system evolves, the risk evaluation level, thus the evaluation frequency, can be reduced, and vice versa. The risk assessment server continues to evaluate the element or entity as described above until the element or entity is removed from the system because, for example, the function is no longer needed or the element or entity does not pass the detailed risk assessment mentioned above.

As described herein, certain aspects provide improvements to the performance of a system by providing early and continuous detection of risks associated with individual components of the system. Depending on the type of the system and risks being evaluated, the technologies presented herein can provide improvements to the security of the system, the response time of the system, the computing efficiency of the system, and the requirement compliance of the system, including service level agreement requirements or regulatory requirements. By frequently evaluating the risks associated with individual elements or entities, problem-causing events can be predicted before they actually occur. This allows a more thorough evaluation to be performed on the element or entity to prevent such events from occurring or to remove the element or entity from the system to avoid the negative impact brought by the element or entity. In addition, the use of an explainable machine learning model allows explanatory data to be generated thereby identify the specific aspects or attributes of the element or entity causing the high risk. This reduces the amount of time and resources associated with identifying the problem with the element or entity.

Operating Environment Example for Continuous Risk Evaluation

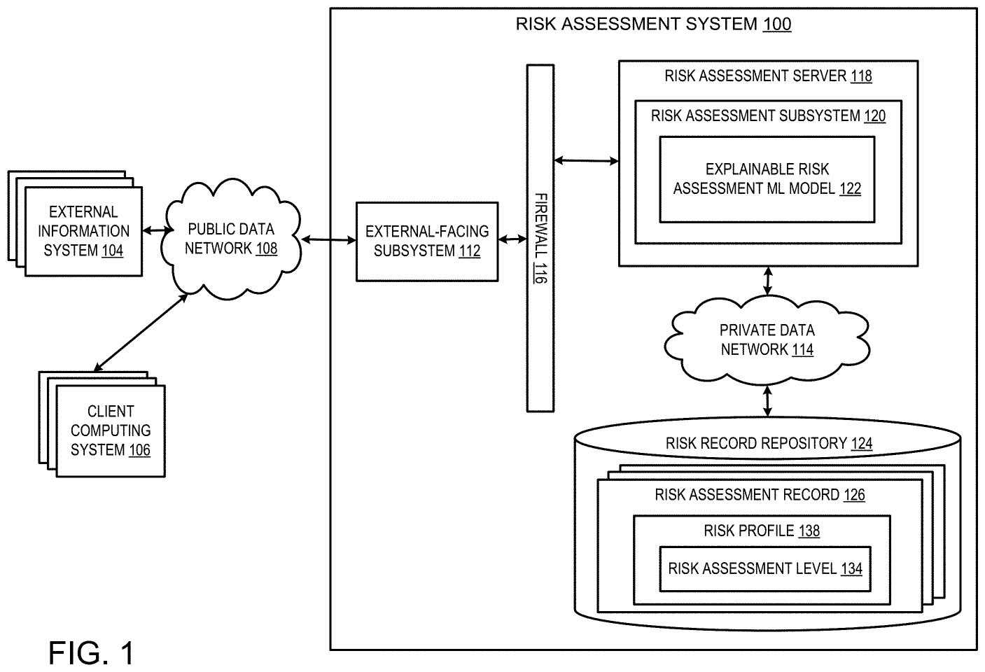

FIG. 1 is a block diagram depicting an example of a risk assessment system 100 for continuously assessing risks associated with the individual service-providing elements or entities for a system, according to certain aspects of the present disclosure. The elements or entities can include hardware computing components (e.g., a processor or chip configured for performing computing functionalities, a storage device for providing storage services, and a network card for enabling network communication), software computing components, a company, or another service provider. The elements or entities can provide functions or services for the system, such as providing computing functionalities, storage services, network communication services, call center operations, cloud-based data storage and computing, or demographic data periodically.

In some examples, risk assessment can be performed on the elements or entities of the system to try to detect risks caused or otherwise associated with individual elements or entities to prevent a system failure. The risks can include, for example, security risks (e.g., the risk of suffering cyber-attacks), performance risks (e.g., the risk of failing to meet the response time requirement), and so on. In other examples, the risk assessment may be performed to meet regulatory requirements, such as the regulations established by the United States Office of Comptroller Currency (OCC) requiring third-party oversight of entities that have a business relationship with a company associated with the system. The business relationship may involve the entity providing a product or service (e.g., outsourced services or data providers) to the company or consumers of the company. Additionally or alternatively, the business relationship may involve the entity performing functions on behalf of the company, such as selling products or assisting consumers in acquiring the products. The regulations require continuously assessing the entity's management, reputation, product performance, and financial condition to determine whether the entity should be investigated further.

The risk assessment system 100 shown in FIG. 1 includes a risk assessment server 118 that is configured for generating a risk profile 138 for an element or entity. The risk assessment system 100 further includes a risk record repository 124 configured for storing risk assessment records for elements or entities associated with the system.

For example, the risk record repository 124 may include a risk assessment record 126 for an element or entity. The risk assessment record 126 can include a risk profile 138 describing a risk assessment level 134 for the element or entity. The risk assessment record 126 is generated in response to the element or entity being added to the system. For instance, the risk assessment server 118 receives a request for evaluating a risk associated with an element or entity configured for providing a certain function or service to the system. In some examples, the risk assessment system 100 is integrated into the system being monitored and thus the request may be submitted by a computing system internal to the system. Alternatively, or additionally, the risk assessment system 100 is separate from the system being monitored and the request may thus be from a client computing system 106 external to the risk assessment system 100.

In response to the request, the risk assessment server 118 obtains information associated with the element or entity to generate the risk profile 138. If the element is a hardware computer component, the risk assessment server 118 can obtain information such as the model number of the element, the manufacturer of the element, the specifications of the element, and so on. If the element is a software component, the risk assessment server 118 can obtain information of the software module such as the version number of the software, the environment or platform that supports the execution of the software, the developer of the software, and so on. If the element or entity is a company or other service provider, the risk assessment server 118 can obtain the information of the entity such as the name and address of the entity.

The risk assessment server 118 can interact with an external information system 104 to obtain information about the element or entity. To do so, the risk assessment server 118 transforms the descriptor of the element or entity, such as the name of the element or entity, into a standardized term or terms. Different terms or descriptors may be used to address the same entity, so standardizing the term can ensure relevant information for the element or entity is stored and searched appropriately. The standardization can be performed, for example, by applying a set of transformation operations to the descriptors or terms. The set of transformation operations can include, but are not limited to, converting the term into a common format, standardizing the tokens or special characters in the term, replacing abbreviations in the term, separating joined words in the term, and so on. Using the standardized terms, the risk assessment server 118 then searches one or more external information systems 104. The external information system(s) 104 include database(s) configured for storing information for various elements or entities. The risk assessment server 118 further retrieves the information associated with the element or entity from the external information system(s) 104.

Based on the obtained information of the element or entity, an initial risk evaluation can be performed for the element or entity. For instance, the risk assessment server 118 or another computing device can execute a cybersecurity tool to evaluate a website associated with the element or entity (e.g., a website describing the element or entity, a website hosted by the entity) and to generate a cybersecurity report. The risk assessment server 118 or another computing device may also obtain, for example from the Internet, other public information of the element or entity, such as the financial data or other data associated with the entity. Data that cannot be publicly obtained may also be obtained, for example, through user input.

The risk assessment server 118 or another computing device can perform the initial risk evaluation based on the gathered information. If it is determined based on the initial risk evaluation that the element or entity can be included in the system, the risk assessment server 118 creates the risk profile 138 for the element or entity in the risk record repository 124. The risk profile 138 comprises the risk assessment level 134 indicating at least a frequency for assessing the risk associated with the element or entity. The frequency of the risk assessments for the element or entity may be monthly, quarterly, semi-annual, annual, etc. If the element or entity is added to provide more than one service or function, the risk assessment server 118 can generate separate risk profiles for each service or function, and each risk profile may include a different frequency for assessing the risk associated with the element or entity. In one example, the risk assessment level 134 is determined based on the function or service provided by the element or entity. The risk assessment level 134 for the element or entity can be set to high if the element or entity is engaged to provide critical functions, such as functions requiring a low response time (e.g., controlling a voltage value for a power grid of the system or controlling a backup power supply for a data center associated with the system). Additionally or alternatively, the risk assessment level 134 can be set to high if the functions or services the entity is engaged to provide involve confidential information, such as personally identifiable information (PII) of users or customers of the system. As a result, the element or entity will be evaluated more frequently. For elements or entities providing less important functions or services (e.g., an entity providing food service to the system), the risk assessment level 134 for the element or entity can be set to be medium or low and risk assessment can be performed less frequently. The risk assessment server 118 further evaluates the risks of the element or entity periodically and continuously according to the frequency.

The risk assessment system 100 determines the time for a risk assessment for the element or entity based on the frequency indicated in the risk profile 138. To perform a risk evaluation, the risk assessment server 118 can utilize a risk assessment subsystem 120 to generate attributes and determine a risk associated with the element or entity. For example, the risk assessment subsystem 120 communicates with the risk record repository 124 to access the risk assessment record 126 for the element or entity and to query the external information system 104 to retrieve updated information associated with the element or entity. For example, the risk assessment subsystem 120 can obtain a list of high-risk entities from the external information system 104 and determine a relationship between the element or entity and the list of high-risk entities. The determination can be made based on, for example, a term associated with the element or entity that is extracted using natural language processing from the information associated with the element or entity. The term can be the name of the hardware device, the name of the company manufacturing the device, a key person of the company or entity, and so on. The list of high-risk entities may be a list of recalled devices, a list of devices that are incompatible with the computing environment of the system, or a list of dangerous or unwelcoming individuals (e.g., politically exposed persons (PEP) list, people on no-fly lists, persons designated as terrorists, terrorist organizations, any entity on the Office of Foreign Assets Control (OFAC) list, etc.). If the term associated with the element or entity matches the list of high-risk entities, the risk assessment subsystem 120 can determine that the entity or element and the list of high-risk entities are related. If the term associated with the element or entity does not match the list of entities, the risk assessment subsystem 120 can determine the entity or element is not related to the list of high-risk entities.

The risk assessment subsystem 120 can be configured to generate other attributes based on other information related to the element or entity that are obtained or updated after the initial risk assessment. The other attributes can include a risk score, such as modeled risk scores for businesses including a Business Delinquency Financial Score (BDFS) or a Business Failure Score (BFS). The BDFS predicts the likelihood of an entity incurring severe delinquency (e.g., 91 days or greater) or charge-off on financial accounts within the next twelve months. The BFS predicts the likelihood of an entity failure through either formal or informal bankruptcy within the next 12 months. The risk score can be calculated and provided by another computing system, such as the external information system 104.

The risk assessment subsystem 120 further inputs the attributes of the element or entity to an explainable risk assessment machine-learning model 122 to generate a predicted risk associated with the element or entity. The explainable risk assessment machine-learning model 122 can be a monotonic neural network for which an output of the monotonic neural network is monotonic to each input attribute or to a value derived from the input attributes. In some examples, the monotonic neural network can be obtained by iteratively adjusting the neural network (e.g., the number of layers, the number of input attributes, the weights associated with neural network nodes) until the monotonic relationship between each input attribute and the output is achieved. In another example, the monotonic neural network can be obtained by iteratively adjusting the neural network until the monotonic relationship between each common factor of the input attributes and the output is achieved. In a further example, the monotonic neural network can be obtained by adding monotonic constraints in the optimization problem used to train the neural network.

The explainable risk assessment machine-learning model 122 can be trained using training data with known risks. The predicted risk is compared with a threshold value of risk to determine if the element or entity has a high risk. The element or entity is determined to have a high risk if the predicted risk is higher than the threshold value. If not, the risk assessment server 118 records the data associated with the current assessment in the risk record repository 124 and continues to monitor the risk of the element or entity according to the risk profile 138.

If the predicted risk is higher than the threshold, the risk assessment subsystem 120 further uses the explainable risk assessment machine-learning model 122 to generate explanatory data identifying the attributes that cause the high risk. For example, the risk assessment subsystem 120 can determine the element has a high predicted risk because the element is on a list of devices that are incompatible with the computing environment of the system. The risk assessment server 118 sends a notification along with the predicted risk and the explanatory data to another computing device, such as the client computing system 106. The notification will cause a more detailed risk analysis of the element or entity, such as the analysis performed in the initial risk assessment. In some examples, the detailed risk analysis is performed for the attributes that cause the high risk as indicated in the explanatory data. Based on the further analysis, the element or entity may be modified to reduce the risk brought by the element or entity to the system. The modifications include, but are not limited to, removing the element or entity from the system, replacing the element or entity with another element or entity providing the same or similar function or service, or repairing, rectifying, or reforming the element or entity to reduce the risk. For example, if the attribute or factor causing the predicted high risk for the element or entity is related to the cybersecurity of the website associated with the element or entity, the element or entity can be modified to change the website (e.g., change the settings of the website, the servers used to host the website, the mechanisms used to implement the website, or the content presented on the website) to reduce or eliminate the risk.

Although in the above example, attributes such as the external risk score, the relationship between the element or entity and the list of high-risk entities are used as input to the machine-learning model to predict the risk associated with the element or entity. Alternatively, or additionally, these attributes may be used separately to trigger the notification. For example, if the risk assessment subsystem 120 determines that the element or entity matches or is otherwise related to the list of high-risk entities, the risk assessment subsystem 120 can send the notification. Likewise, the risk assessment subsystem 120 can be configured to send a notification if any of the external risk scores is higher than a threshold. In addition, the input attributes to the machine-learning model may use more or fewer attributes as input to perform the prediction than those described above.

In some examples, the risk assessment server 118 further updates the risk profile 138 of the element or entity based on the data obtained during the risk assessment and the predicted risk. For instance, if the service or function provided by the element or entity becomes less important as the system evolves, the risk assessment level 134, thus the evaluation frequency, can be reduced, and vice versa. The risk assessment server 118 continues to evaluate the element or entity as described above until the element or entity is removed from the system because, for example, the function is no longer needed or the element or entity does not pass the detailed risk assessment mentioned above.

The risk record repository 124 maintains a record for each of the risk assessments for an entity or element. The risk record repository 124 periodically, or upon request, or at the time of requesting risk assessment for the element or entity, sends the recorded risk assessment records to the risk assessment system 100 so that the risk associated with the entity or element may be analyzed in more detail.

The risk assessment system 100 also includes a client external-facing subsystem 112 including one or more computing devices to provide a physical or logical subnetwork (sometimes referred to as a “demilitarized zone” or a “perimeter network”). The client external-facing subsystem 112 is configured to expose certain online functions of the risk assessment system 100 to an untrusted network, such as the Internet or another public data network 108. In some aspects, the client external-facing subsystem 112 can be implemented as edge nodes, which provide an interface between the public data network 108 and a cluster computing system, such as a Hadoop cluster used by the risk assessment system 100.

The client external-facing subsystem 112 is communicatively coupled, via a firewall device 116, to one or more computing devices forming a private data network 114. The firewall device 116, which can include one or more devices, creates a secured part of the risk assessment system 100 that includes various devices in communication via the private data network 114. In some aspects, by using the private data network 114, the risk assessment system 100 can house the risk record repository 124 in an isolated network (i.e., the private data network 114) that has no direct accessibility via the Internet or another public data network 108.

Various computing systems may interact with the risk assessment system 100 through the client external-facing subsystem 112, such as one or more external information systems 104. The external information system 104 can include one or more devices, such as individual servers or groups of servers operating in a distributed manner. An external information system 104 can include any computing device or group of computing devices operated by a seller, lender, or another provider of products or services. The external information system 104 can include one or more server devices that include or otherwise access one or more non-transitory computer-readable media. The external information system 104 can also execute an online service. The online service can include executable instructions stored in one or more non-transitory computer-readable media. The external information system 104 can include a system hosting a database where information about the element or entity is searched, external sources for credit scores such as commercial credit scores, the BDFS, and the BFS, a website providing the PEP list, or a website providing the no-fly lists, persons designated as terrorists, terrorist organizations, the OFAC list, denied persons list, official lists of restricted parties, etc.

The client computing system 106 may include any computing device or other communication device operated by an individual or an entity, such as a company, an institute, an organization, or other types of entities.

In some examples, the client computing system 106 may submit a request to the risk assessment system 100 to identify a predicted risk associated with an entity or element that provides a function or service for a system associated with the client computing system 106. For example, the client computing system 106 may submit a request to continuously evaluate the risk of individual entities or elements of the system. The request may be submitted by the client computing system 106 before or after the individual entities or elements are added to the system associated with client computing system 106.

The risk assessment system 100 can process such a request using the risk assessment subsystem 120 and the external information system 104 as discussed above and return the results of the analysis to the client computing system 106 periodically. For example, the risk assessment subsystem 120 can return notification or warning messages to the client computing system 106 listing the entities and elements who have been identified as high-risk entities or potential high-risk entities. Other results can also be generated and returned to the client computing system 106.

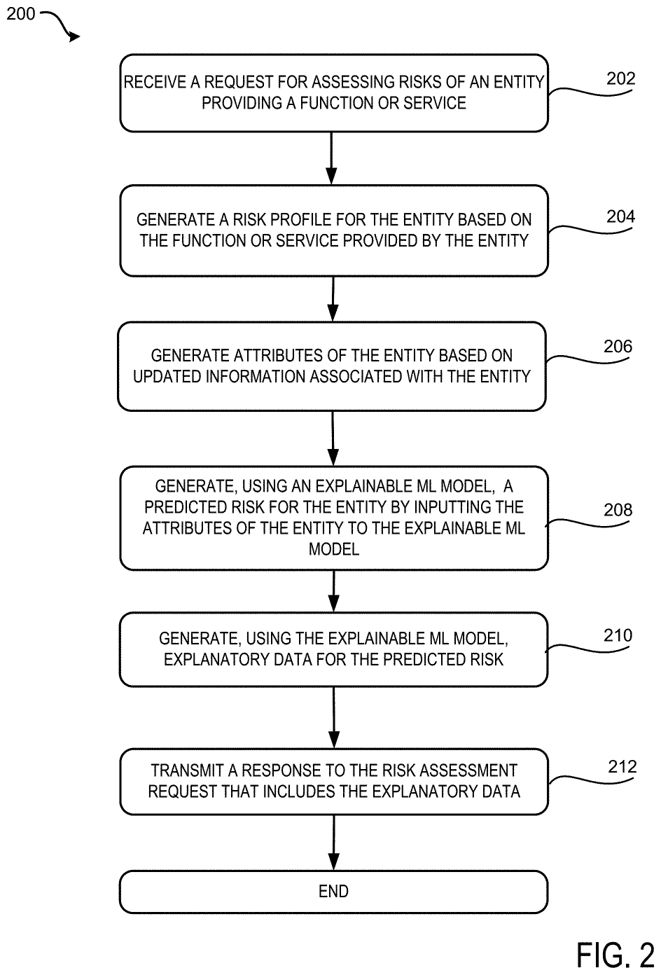

FIG. 2 is a flow chart illustrating an example of a process 200 for continuously assessing risks associated with the individual service-providing elements or entities for a system, according to certain aspects of the present disclosure. For illustrative purposes, the process 200 is described with reference to implementations described above with respect to one or more examples described herein. Other implementations, however, are possible. In some aspects, the steps in FIG. 2 may be implemented in program code that is executed by one or more computing devices such as the risk assessment server 118 depicted in FIG. 1. In some aspects of the present disclosure, one or more operations shown in FIG. 2 may be omitted or performed in a different order. Similarly, additional operations not shown in FIG. 2 may be performed.

At block 202, the process 200 involves receiving a request for assessing risks of an element or entity providing a function or service. The function or service can be a computing service, storage service, network communication service, call center operations, cloud-based data storage, and computing service, or a periodic supplier of demographic data. The risk assessment server 118 can receive the request in response to the element or entity being added to the system. The risk assessment server 118 can receive the request from a client computing system 106 or from a device within the risk assessment system 100 as described above with respect to FIG. 1.

At block 204, the process 200 involves generating a risk profile 138 for the element or entity based on the function or service provided by the element or entity. For example, if the function or service the element or entity provides involves a critical function for the system, the risk profile 138 can include a risk assessment level 134 that indicates high risk and involves more frequent risk assessments than if the service or function provided by the element or entity involves a non-critical function for the system. The risk assessment level 134 can include categorical values (e.g., low, medium, and high) or numerical values (e.g., 1, 2, . . . , 5). The risk assessment server 118 assigns a value to the frequency for assessing a risk associated with the element or entity based on the risk assessment level 134. A higher frequency value is assigned to a higher risk assessment level, and vice versa.

At block 206, the process 200 involves generating attributes of the element or entity based on updated information associated with the element or entity. As described above with respect to FIG. 1, the attributes can include a relationship between the element or entity and one or more lists of high-risk entities (e.g., a list of recalled devices, a list of devices that are incompatible with the computing environment of the system, or a list of dangerous or unwelcoming individuals). The risk assessment system 110 can obtain the lists of high-risk entities from external data sources (e.g., the external information system(s) 104) and determining whether a keyword associated with the element or entity extracted from information associated with the element or entity matches a term on a list of high-risk entities. The attributes may also include one or more risk scores calculated by another computing system, such as BDFS and BFS of the entity if the entity is a business. In some examples, the keyword can be extracted using natural language processing. For instance, the risk assessment server 118 can parse the information associated with the element or entity and to identify and extract keywords associated with the element or entity from the parsed information, such as the model number of the device, the make year of the device, the key persons associated with the entity, and so on.

At block 208, the process 200 involves generating, using a machine learning model (e.g., the explainable risk assessment machine-learning model 122), predicted risk for the element or entity by inputting the attributes of the element or entity into the explainable machine learning model. In some examples, the explainable risk assessment machine-learning model 122 is a monotonic neural network for which the output of the monotonic neural network is monotonic to each input attribute or to a value derived from the input attributes. The explainable risk assessment machine-learning model 122 can be trained using training data including the input attributes and corresponding output risks.

At block 210, the process 200 involves generating, using the explainable machine learning model, explanatory data for the predicted risk. The explanatory data can indicate which attributes contribute to the predicted high risk more than others. For example, the explanatory data can indicate that the predicted risk is higher than the threshold because the element is a recalled device on the list of high-risk entities.

At block 212, the process 200 involves transmitting a response or a notification in response to the risk assessment request that includes the explanatory data. The response or notification can include an indication of the predicted risk and, if the predicted risk is above the threshold, the reason for the high predicted risk. The response or notification can be sent to a computing device associated with the system being evaluated or to an external computing device (e.g., the client computing system 106), if the request for assessing the risks is received from the external computing device. The computing device can initialize a more thorough risk evaluation of the element or entity based on the response or notification including the explanatory data.

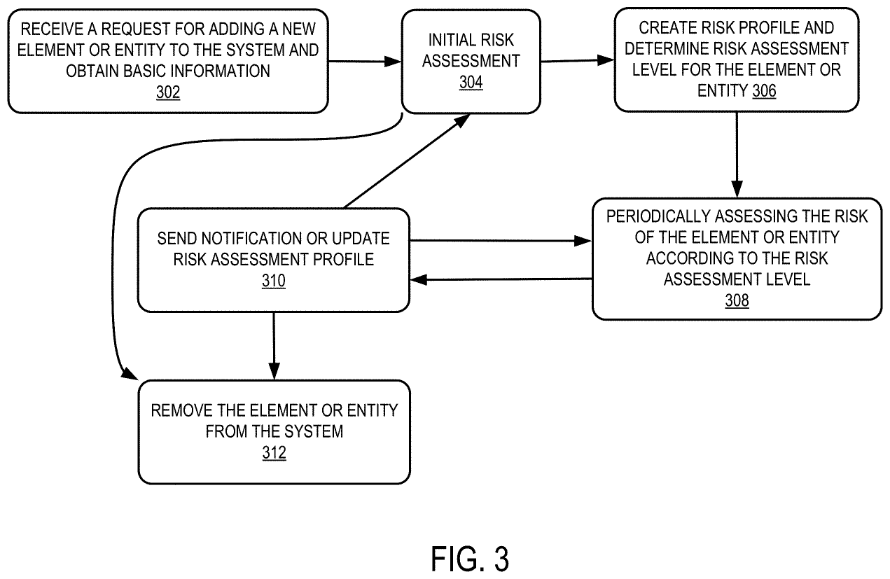

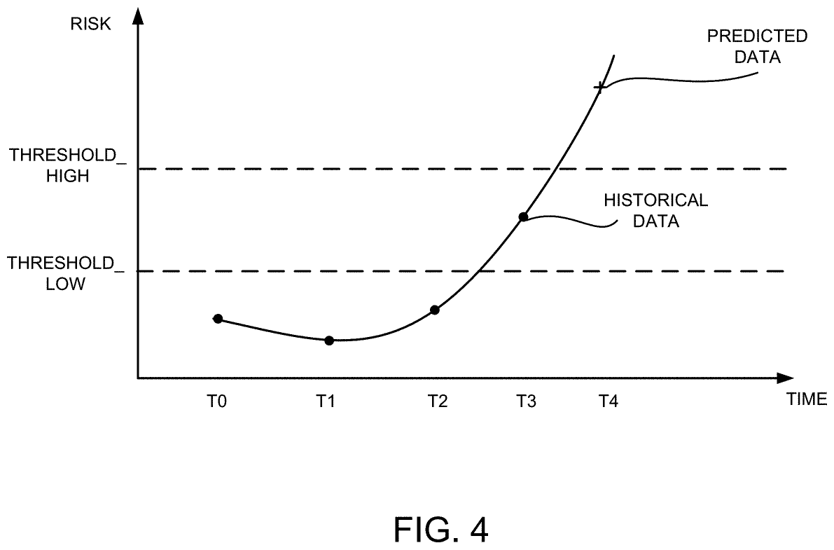

FIG. 3 is a diagram illustrating the various stages involved in a process from adding the element or entity to the system to the removal of element or entity from the system, according to certain aspects of the present disclosure. FIG. 3 will be described in conjunction with FIG. 4 which shows a diagram illustrating the risks associated with an element or an entity as determined and predicted over time, according to certain aspects of the present disclosure.

At stage 302, a risk assessment server 118 receives a request for adding a new element or entity to the system and obtains basic information of the element or entity. The new element or entity is added to provide a certain function or service for the system. To obtain the basic information of the element or entity, the risk assessment server 118 can use the name or other descriptive term of the entity or element and search the name in a database configured for storing the basic information of entities or elements. For example, the database can be a database configured for storing model numbers, specifications, or other aspects of various hardware components for systems similar to the system (e.g., a power control system) being monitored by the risk assessment server 118. If the system is an enterprise system, the database can be database configured for storing the name, address of various service vendors for enterprises. In some scenarios, the name of the entity or element is not standardized (e.g., there are multiple names referring to the same entity or element), the risk assessment server 118 can transform the name into a standardized term as described above with respect to FIG. 2 and use the standardized term to search the database. The retrieved basic information can be stored in the risk record repository 124.

At stage 304, the risk assessment server 118 performs an initial risk assessment for the entity or element. The initial risk assessment involves various investigations into the entity or element. For example, the risk assessment server 118 can execute a cybersecurity tool to extract information about the element or entity from a website associated with the entity or element. The risk assessment server 118 may additionally or alternatively retrieve other information, such as financial information or security information associated with the entity or element. The risk assessment server 118 can retrieve the information from one or more external information systems 104, or via input by a user or from an internal data source. In some examples, the initial risk assessment is performed according to the regulation or internal policy of the system.

At stage 306, the risk assessment server 118 creates a risk profile 138 and determines a risk assessment level 134 for the element or entity. The risk profile 138 is created in response to the initial risk assessment being satisfactory and is based on the function or service provided by the element or entity. As described above with respect to FIGS. 1 and 2, the risk assessment level 134 for the element or entity can be set to high if the element or entity is engaged to provide critical functions, such as functions requiring a low response time. Additionally or alternatively, the risk assessment level 134 can be set to high if the functions or services the element or entity is engaged to provide involve confidential information, such as PII of users or customers of the system. For elements or entities providing less important functions or services, such as providing food service to the system, the risk assessment level 134 for the element or entity can be set to be medium or low. The risk assessment level 134 indicates or otherwise is used to specify a frequency for assessing the risk associated with the entity or element. A higher risk assessment level may be associated with more frequent risk assessments for the entity or element and vice versa. For example, for an entity that performs a function that involves Fair Credit Reporting Act (FCRA) regulated data, the risk assessment level 134 may be set to be high thereby involving more frequent risk assessments. Risk assessment levels and the corresponding frequency of risk assessments can be determined based on the overall functionality of the system requesting the risk assessment or the goal of the risk assessment.

At stage 308, the risk assessment server 118 periodically assesses the risk of the element or entity according to the risk assessment level 134. The risk assessment server 118 can determine the time to perform the risk assessment based on the frequency indicated in the risk assessment level 134. The risk can be assessed based on one or more lists of high-risk entities that the risk assessment server 118 receives from external data source(s). The lists of high-risk entities can include a list of recalled devices, a list of devices that are incompatible with a computing environment of the system, a PEP list, a no-fly list, etc. The risk assessment server 118 can determine attributes of the element or entity that include a relationship between the element or entity and the list of high-risk entities. The relationship is determined based on a keyword associated with the element or entity (e.g., the name of the hardware device, the name of the company manufacturing the device, a key person of the company or entity, etc.) matching a high-risk entity in these lists. Additionally or alternatively, the attributes can include a risk score, such as a BDFS or a BFS from another computing system. If the risk assessment server 118 determines the keyword matches a term on the list of high-risk entities or that the risk score is above a threshold, a notification can be transmitted to the client computing system 106 for use to further evaluate the element or entity.

The risk may additionally be assessed using a machine learning model configured for forecasting risks for an element or entity based on input attributes. In some examples, the machine learning model is an explainable machine learning model. FIG. 4 is a diagram illustrating the risks associated with an element or an entity as determined and predicted over time, according to certain aspects of the present disclosure. The attributes (e.g., the attributes generated above) can be input into the machine learning model, and based on the attributes, the machine learning model generates a predicted risk for the element or entity. Each previous risk assessment for the element or entity can be a historical data point that can be used, along with the predicted risk, to determine a trend of the risk of the element or entity. The trend analysis may be done for individual categories of attributes (e.g., failure risk, financial risk, political risk, etc.) or for a combination of one or more categories. As shown in FIG. 4, the machine learning model predicts that at time T4 the risk will be above a high threshold. A predicted risk below a low threshold can be considered low risk, a predicted risk between the low threshold and the high threshold can be considered a medium risk, and a predicted risk above the high threshold can be considered high risk. A predicted high risk can cause the risk assessment server 118 to generate a notification for further evaluation of the element or entity. If the machine-learning model is an explainable machine learning model, the risk assessment server 118 may further use the explainable machine learning model to generate explanatory data indicating the main attributes that contribute to the high risk. In these examples, the notification may include explanatory data determined by the explainable machine learning model.

Alternatively, or additionally, the notification is generated based on individual attributes. For example, the notification can be generated in response to the keyword associated with the element or entity matching a list of high-risk entities, or an external risk score being above a threshold.

At stage 310, the risk assessment server 118 sends the notification for further evaluation to another computing device, such as the device associated with an administrator of the system being monitored. The notification can be sent based on rules associated with the entity or element. For example, the notification of a risk score being above a threshold may be sent to a device associated with a first user and the notification of the keyword matching the list of high-risk entities may be sent to a device associated with a second user. The user(s) can then take proper actions to evaluate the entity or element and its associated risk to the system. As shown in FIG. 3, the notification may cause the risk assessment performed in the initial risk assessment to be performed again, and thus return the stage to the initial risk assessment stage. If the further risk assessment is unsatisfactory, the process can move to stage 312 where the element or entity is removed from the system. If the further risk assessment is unsatisfactory, the process may move to stage 306 to update the risk profile of the element or entity and continue the periodic evaluation at stage 308.

At stage 310, if no notification or alert is generated for the element or entity, the risk assessment server 118 may update the risk profile 138 for the element or entity. For example, the risk profile 138 can be updated according to the predicted risk, which may result in a change in the risk assessment level 134 and the frequency at which the risk assessment server 118 evaluates the risk of the entity or element. For example, if the predicted risk for the element or entity is higher than a threshold value (e.g., the low threshold shown in FIG. 4), but lower than the threshold triggering the notification (e.g., the high threshold shown in FIG. 4), the risk assessment server 118 can increase the risk level for the entity thereby increasing the risk evaluation frequency. In this example, although no notification is generated for the element or entity, the element or entity is evaluated more frequently due to its increased risk which allows issues associated with the element or entity to be identified earlier. The risk assessment server 118 continues to assess the risk of the element or entity based on the updated risk profile at stage 308.

At stage 312, the risk assessment server 118 removes the element or entity from the system. The element or entity may be removed if the function is no longer needed or the element or entity does not pass the detailed risk assessment mentioned above including the initial risk assessment and the further risk assessment triggered by the notification. Additionally, changes in personnel or devices associated with the element or entity can cause the risk assessment server 118 to initiate a thorough review of the risk of the element or entity. If the element or entity no longer passes the risk assessment, the element or entity can be removed from the system.

Example of Computing Environment for Continuous Risk Assessment

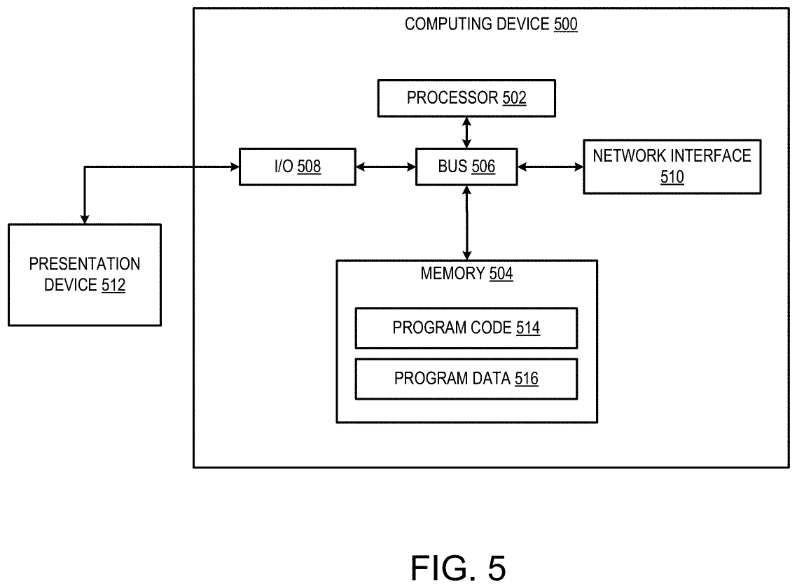

Any suitable computing system or group of computing systems can be used to perform the operations for continuously assessing risks associated with individual service-providing elements or entities for a system described herein. For example, FIG. 5 is a block diagram depicting an example of a computing device 500, which can be used to implement the risk assessment server 118, the external information system 104, or the client computing system 106. The computing device 500 can include various devices for communicating with other devices in the risk assessment system 100, as described with respect to FIG. 1. The computing device 500 can include various devices for performing one or more risk assessment operations described above with respect to FIGS. 1-4.

The computing device 500 can include a processor 502 that is communicatively coupled to a memory 504. The processor 502 executes computer-executable program code stored in the memory 504, accesses information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 502 include a microprocessor, an application-specific integrated circuit, a field-programmable gate array, or any other suitable processing device. The processor 402 can include any number of processing devices, including one. The processor 502 can include or communicate with a memory 504. The memory 504 stores program code that, when executed by the processor 502, causes the processor to perform the operations described in this disclosure.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Scala, Python, Perl, JavaScript, ActionScript, etc.

The computing device 500 may also include a number of external or internal devices such as input or output devices. For example, the computing device 500 is shown with an input/output interface 508 that can receive input from input devices or provide output to output devices. A bus 506 can also be included in the computing device 500. The bus 506 can communicatively couple one or more components of the computing device 500.

The computing device 500 can execute program code 514 such as the risk assessment subsystem 120. The program code 514 may be resident in any suitable computer-readable medium and may be executed on any suitable processing device. For example, as depicted in FIG. 5, the program code 514 can reside in the memory 504 at the computing device 500 along with the program data 516 associated with the program code 514, such as the reporting message, the resource value prediction model, or the predicted value. Executing the program code 514 can configure the processor 502 to perform the operations described herein.

In some aspects, the computing device 500 can include one or more output devices. One example of an output device is the network interface device 510 depicted in FIG. 5. A network interface device 510 can include any device or group of devices suitable for establishing a wired or wireless data connection to one or more data networks described herein. Non-limiting examples of the network interface device 510 include an Ethernet network adapter, a modem, etc.

Another example of an output device is the presentation device 512 depicted in FIG. 5. A presentation device 512 can include any device or group of devices suitable for providing visual, auditory, or other suitable sensory output. Non-limiting examples of the presentation device 512 include a touchscreen, a monitor, a speaker, a separate mobile computing device, etc. In some aspects, the presentation device 512 can include a remote client-computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method comprising one or more processing devices performing operations comprising:
receiving a request for evaluating a risk associated with an entity providing a function or service;
generating a risk profile for the entity based, at least in part, upon the function or service provided by the entity, the risk profile comprising a risk assessment level indicating at least a frequency for assessing the risk associated with the entity;
in response to determining, based on the risk profile, that a time for assessing the risk associated with the entity has arrived,
generating attributes of the entity based on updated information associated with the entity, wherein the attributes of the entity comprise a relationship between the entity and a list of high-risk entities that is determined by:
obtaining the list of high-risk entities from an external data source; and
determining the relationship between the entity and the list of high-risk entities;
generating, using an explainable risk assessment machine-learning model, a predicted risk associated with the entity by inputting the attributes of the entity to the explainable risk assessment machine-learning model;
generating, using the explainable risk assessment machine-learning model, explanatory data associated with the entity based on the predicted risk being higher than a threshold, the explanatory data indicating the attributes of the entity that cause the predicted risk to be higher than the threshold; and
sending the explanatory data and a notification to another computing device for use in further evaluating the entity based on the explanatory data and modifying the entity.

2. The method of claim 1, further comprising executing a cybersecurity tool to extract information about the entity from a website associated with the entity or retrieving information about the entity from a remote computing system.

3. The method of claim 1, wherein generating the risk profile for the entity based, at least in part, upon the function or service provided by the entity comprises:
determining a risk level based on the function or service provided by the entity; and
assigning a value to the frequency for assessing a risk associated with the entity based on the risk level.

4. The method of claim 1, further comprising retrieving information associated with the entity for evaluating by:
transforming a name of the entity into a standardized term;
searching, in a data store configured for storing information for entities, for the entity using the standardized term; and
retrieving, from the database, the information associated with the entity.

5. The method of claim 2, wherein determining the relationship between the entity and the list of high-risk entities comprises:
analyzing the information associated with the entity to extract a term associated with the entity using natural language processing;
determining a match between the term associated with the entity with the list of high-risk entities; and
determining that the entity is not related to the list of high-risk entities in response to determining that no match is found between the term associated with the entity with the list of high-risk entities.

6. The method of claim 1, wherein the attributes of the entity further comprise a risk score calculated by another computing system.

7. The method of claim 1, wherein the entity is associated with a second risk profile generated for the entity providing a second function or second service that is different from the function or service.

8. The method of claim 1, wherein the explainable risk assessment machine-learning model comprises a monotonic neural network for which an output of the monotonic neural network is monotonic to each of input attributes of the monotonic neural network or monotonic to a value derived from the input attributes.

9. The method of claim 1, further comprising:
updating the risk profile based on the predicted risk associated with the entity by at least changing the frequency for assessing the risk associated with the entity.

10. A risk evaluation system, comprising:
a processing device; and
a memory device in which instructions executable by the processing device are stored for causing the processing device to perform operations comprising:
receiving a request for evaluating a risk associated with an entity providing a function or service;
generating a risk profile for the entity based, at least in part, upon the function or service provided by the entity and storing the risk profile in a risk assessment record associated with the entity, the risk profile comprising a risk assessment level indicating at least a frequency for assessing the risk associated with the entity;
in response to determining, based on the risk profile, that a time for assessing the risk associated with the entity has arrived,
generating attributes of the entity based on updated information associated with the entity, wherein the attributes of the entity comprise a relationship between the entity and a list of high-risk entities that is determined by:
obtaining the list of high-risk entities from an external data source;
determining the relationship between the entity and the list of high-risk entities based on a keyword associated with the entity extracted from information associated with the entity;
generating, using an explainable risk assessment machine-learning model, a predicted risk associated with the entity by inputting the attributes of the entity to the explainable risk assessment machine-learning model;
generating, using the explainable risk assessment machine-learning model, explanatory data associated with the entity based on the predicted risk being higher than a threshold, the explanatory data indicating the attributes of the entity causing the predicted risk higher than the threshold; and
sending the explanatory data and a notification to another computing device for use in further evaluating the entity based on the explanatory data and modifying the entity.

11. The risk evaluation system of claim 10, wherein the operations further comprise executing a cybersecurity tool to extract information about the entity from a website associated with the entity or retrieving information about the entity from a remote computing system.

12. The risk evaluation system of claim 10, wherein generating the risk profile for the entity based, at least in part, upon the function or service provided by the entity comprises:
determining a risk level based on the function or service provided by the entity; and
assigning a value to the frequency for assessing a risk associated with the entity based on the risk level.

13. The risk evaluation system of claim 10, wherein the operations further comprise retrieving information associated with the entity for evaluating by:
transforming a name of the entity into a standardized term;
searching, in a data store configured for storing information for entities, for the entity using the standardized term; and
retrieving, from the database, the information associated with the entity.

14. The risk evaluation system of claim 11, wherein determining the relationship between the entity and the list of high-risk entities comprises:
analyzing the information associated with the entity to extract a term associated with the entity using natural language processing;
determining a match between the term associated with the entity with the list of high-risk entities; and
determining that the entity is not related to the list of high-risk entities in response to determining that no match is found between the term associated with the entity with the list of high-risk entities.

15. The risk evaluation system of claim 10, wherein the attributes of the entity further comprise a risk score calculated by another computing system.

16. A non-transitory computer-readable storage medium having program code that is executable by a processor device to cause a computing device to perform operations, the operations comprising:
receiving a request for evaluating a risk associated with an entity providing a function or service;
generating a risk profile for the entity based, at least in part, upon the function or service provided by the entity, the risk profile comprising a risk assessment level indicating at least a frequency for assessing the risk associated with the entity;
in response to determining, based on the risk profile, that a time for assessing the risk associated with the entity has arrived,
generating attributes of the entity based on updated information associated with the entity, wherein the attributes of the entity comprise a relationship between the entity and a list of high-risk entities that is determined by:
obtaining the list of high-risk entities from an external data source;
determining the relationship between the entity and the list of high-risk entities based on a keyword associated with the entity extracted from information associated with the entity;
generating, using an explainable risk assessment machine-learning model, a predicted risk associated with the entity by inputting the attributes of the entity to the explainable risk assessment machine-learning model;
generating, using the explainable risk assessment machine-learning model, explanatory data associated with the entity based on the predicted risk being higher than a threshold, the explanatory data indicating the attributes of the entity causing the predicted risk higher than the threshold; and
sending the explanatory data and a notification to another computing device for use in further evaluating the entity based on the explanatory data and modifying the entity.

17. The non-transitory computer-readable storage medium of claim 16, wherein the operations further comprise executing a cybersecurity tool to extract information about the entity from a website associated with the entity or retrieving information about the entity from a remote computing system.

18. The non-transitory computer-readable storage medium of claim 16, wherein generating the risk profile for the entity based, at least in part, upon the function or service provided by the entity comprises:
determining a risk level based on the function or service provided by the entity; and
assigning a value to the frequency for assessing a risk associated with the entity based on the risk level.

19. The non-transitory computer-readable storage medium of claim 16, wherein the operations further comprise retrieving information associated with the entity for evaluating by:
transforming a name of the entity into a standardized term;
searching, in a data store configured for storing information for entities, for the entity using the standardized term; and
retrieving, from the database, the information associated with the entity.

20. The non-transitory computer-readable storage medium of claim 17, wherein determining the relationship between the entity and the list of high-risk entities comprises:
analyzing the information associated with the entity to extract a term associated with the entity using natural language processing;
determining a match between the term associated with the entity with the list of high-risk entities; and
determining that the entity is not related to the list of high-risk entities in response to determining that no match is found between the term associated with the entity with the list of high-risk entities.
